(19) United States
(12) Patent Application Publication
(10) Pub. No.: US 2007/0206455 A1
(43) Pub. Date: Sep. 6, 2007

(54) Optical device and method for manufacturing the same

(76) Inventors: Masanori Minamio, Osaka (JP); Yutaka Harada, Kyoto (JP); Kiyokazu Itoi, Osaka (JP); Toshiyuki Fukuda, Kyoto (JP)

Correspondence Address: MCDERMOTT WILL & EMERY LLP, 600 13TH STREET, NW, WASHINGTON, DC, 20005-3096, US

(21) Appl. No.: 11/708,472

(22) Filed: Feb. 21, 2007

(30) Foreign Application Priority Data
Mar. 6, 2006 (JP) 2006-059525

(51) Int. Cl. G11B 7/00

(52) U.S. Cl. 369/44.27

(57) ABSTRACT

An optical device includes a substrate, an optical element, a translucent component, a plurality of first terminals and a sealant. The sealant is located lower than the top surface of the translucent component. The top surface of the translucent component is exposed out of the sealant, while the side surface of the translucent component is covered with the sealant.

### BACKGROUND OF THE INVENTION

1. Field of the Invention

The present invention relates to an optical device and a method for manufacturing the same. In particular, it relates to a resin-sealed optical device and a method for manufacturing the same.

2. Description of Related Art

Electronic devices such as mobile phones and terminal units incorporate semiconductor devices therein. In the semiconductor devices, IC chips perform specified processing in response to external voltage applied thereto. The IC chips are mounted on a substrate provided with internal and external terminals. The internal terminals are connected to electrode terminals of the IC chips via thin conductive wires. The external terminals are solder balls, for example, and electrically connected to the internal terminals and external voltage is applied thereto. In recent years, reduction in size and thickness of the electronic devices has been demanded and a study has been actively made to meet the demand. Some of the achievements of the study are described below.

Patent Publication WO98/35382 discloses a technique of forming a conductive film as an external terminal on part of the rear surface of the substrate. As the solder balls serving as the external terminals are replaced with the conductive film, the obtained semiconductor device is thinned down by the diameter of the solder balls.

Patent Publication U.S. Pat. No. 6,586,824B1 discloses a semiconductor device without a substrate. This semiconductor device is fabricated in the following manner. First, IC chips and internal terminals are implemented on polyamide tape and sealed in a resin. Then, the tape is peeled off to form the solder balls on the surface from which the tape is peeled off. Due to the inexistence of the substrate, the obtained semiconductor device is thinned down by the thickness of the substrate.

### SUMMARY OF THE INVENTION

An optical device of the present invention includes: a substrate; an optical element mounted on one of the surfaces of the substrate to receive or emit light; a plate-shaped translucent component whose bottom surface is bonded to a top surface of the optical element; a plurality of terminals provided on the periphery of said one of the surfaces of the substrate and electrically connected to the optical element; and a sealant provided on said one of the surfaces of the substrate to seal the optical element therein, wherein the sealant is located lower than a top surface of the translucent component and a top surface of the translucent component is exposed out of the sealant a side surface of the translucent component is covered with the sealant.

Since the translucent component is bonded to the optical element, there is no need of forming ribs for keeping the translucent component separated from the optical element.

Further, as the side surface of the sealant is covered with the sealant, stray light is prevented from entering the optical element through the side surface.

A method according to the present invention is a method for manufacturing an optical device including an optical element for receiving or emitting light. The method includes the steps of: (a) providing a plurality of terminals on the periphery of one of the surfaces of a substrate; (b) fixing the optical element onto said one of the surfaces of the substrate; (c) bonding a bottom surface of a plate-shaped translucent component to a top surface of the optical element; (d) electrically connecting the plurality of terminals and the optical element to provide a first intermediate structure; (e) laying a sealing film extending substantially parallel to the substrate on a top surface of the translucent component; (f) injecting resin between the sealing film laid on the translucent component and the substrate to seal the optical element therein; and (g) removing the sealing film from the translucent component after the step (f).

According to this method, the optical element and the translucent component are stacked on the substrate and fixed thereto. This makes it possible to fabricate the optical device without the step of forming ribs for keeping the translucent component separated from the optical element.

Further, in the sealing step, the resin is injected between the sealing film laid on the translucent component and the substrate. Therefore, the resin does not flow onto the surface of the translucent component, while all the side surface of the translucent component is covered with the resin.

### BRIEF DESCRIPTION OF THE DRAWINGS

FIG. 1 is a perspective view illustrating an image pickup device of a first embodiment.

FIG. 2A is a plan view illustrating the image pickup device of the first embodiment.

FIG. 2B is a sectional view taken along the line IIB-IIB shown in FIG. 2A.

FIG. 3 is an enlarged sectional view illustrating a major part of the image pickup device of the first embodiment.

FIG. 4 is an enlarged sectional view illustrating an image pickup region of an image pickup element of the first embodiment.

FIG. 5 is an enlarged sectional view illustrating a major part of a first comparative image pickup device to the first embodiment.

FIG. 6 is an enlarged sectional view illustrating a major part of a second comparative image pickup device to the first embodiment.

FIGS. 7A to 7C are sectional views illustrating some steps of a method for manufacturing the image pickup device of the first embodiment.

FIGS. 8A to 8C are sectional views illustrating the other steps of the method for manufacturing the image pickup device of the first embodiment.

FIG. 9 is a sectional view illustrating some steps of a method for manufacturing an image pickup device of a second embodiment.

FIG. 10 is a sectional view illustrating the structure of an image pickup device of a third embodiment.

FIG. 11 is a sectional view illustrating the structure of an image pickup device of a fourth embodiment.

### DETAILED DESCRIPTION OF THE INVENTION

Optical devices such as light-emitting devices and image pickup devices are examples of the semiconductor devices. In addition to the reduction in size and thickness, these optical devices are also required to achieve improvement in sensitivity to light. From this aspect, the present invention provides an optical device which achieves both of the reduction in size and thickness and the improvement in sensitivity to light, as well as a method for manufacturing the same.

Hereinafter, explanation of embodiments of the present invention will be provided with reference to the drawings. However, the invention is not limited thereto.

### First Embodiment

In the first embodiment of the invention, an image pickup element and an image pickup device are taken as examples of the optical element and the optical device, respectively. Explanation of the structure of the image pickup device and a method for manufacturing the same are provided below.

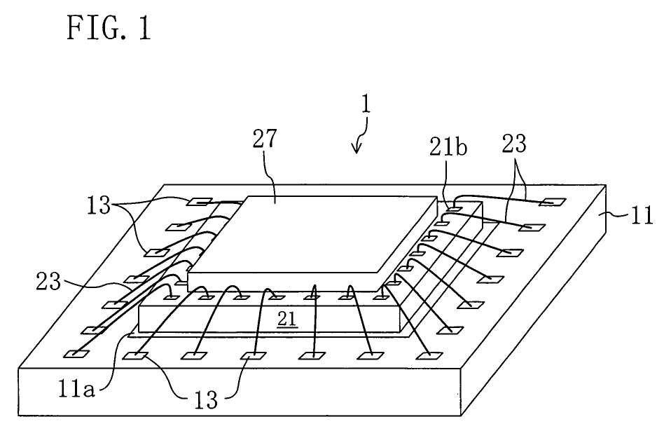

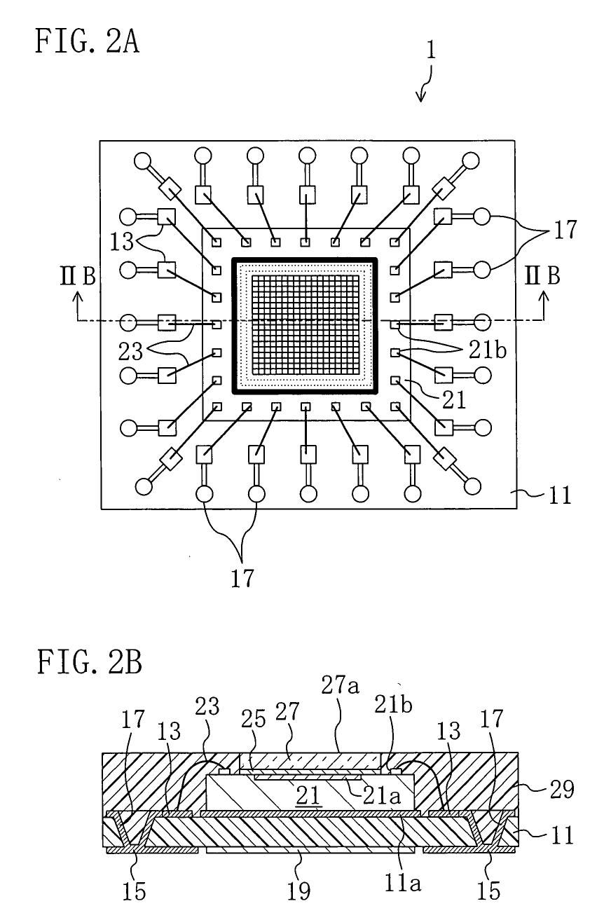

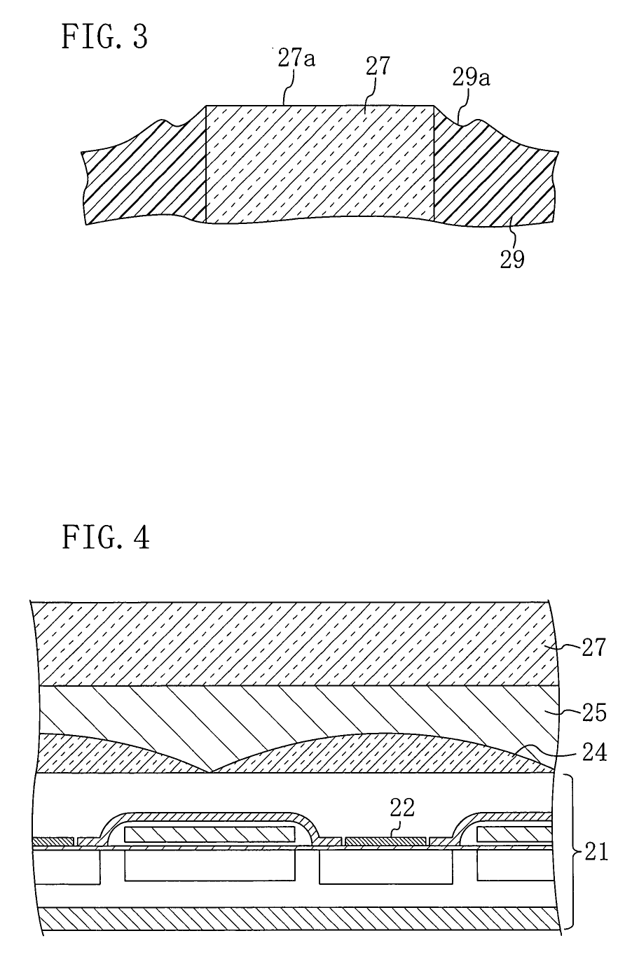

FIGS. 1 to 4 show the structure of an image pickup device 1 of the present embodiment. FIG. 1 is a perspective view of the image pickup device 1, FIG. 2A is a plan view of the image pickup device 1 and FIG. 2B is a sectional view taken along the line IIB-IIB shown in FIG. 2A. FIG. 3 is an enlarged sectional view illustrating the 25 neighborhood of a top surface 27a of a translucent component 27 of the image pickup device 1 and FIG. 4 is a sectional view illustrating the structure of an image pickup region 21a of an image pickup element 21; In FIGS. 1 and 2A, a sealant 29 is omitted.

The image pickup device 1 of the present embodiment includes a substrate 11, an image pickup element 21, a plurality of first terminals (terminals) 13, a plurality of second terminals 15, a translucent component 27 and a sealant 29. In the image pickup device 1, an optical signal received by the image pickup element 21 is converted into an electrical signal to perform image analysis upon application of external voltage to the second terminals 15.

The substrate 11 may be a resin substrate made of glass epoxy resin, amide resin, polyimide resin or acrylic resin and the thickness thereof is preferably not less than 60 μm and not more than 200 μm. A mount region 11a is defined in the middle of the top surface of the substrate 11 (one of the surfaces of the substrate), to which the image pickup element 21 is fixed. In part of the substrate 11 outside the mount region 11a, a plurality of conductive parts 17 penetrating the substrate 11 are arranged to be spaced from each other. The first terminals 13 extend from the conductive parts 17 toward the middle of the top surface of the substrate 11, but not in contact with the mount region 11a.

On the bottom surface of the substrate 11 (the other surface of the substrate), the second terminals 15 extend from the conductive parts 17. To be more specific, the first terminals 13 and the second terminals 15 are electrically connected to each other via the conductive parts 17, respectively. A resist film 19 is formed on the bottom surface of the substrate 11 to prevent short circuit from occurring between the second terminals 15.

The mount region 11a, the first terminals 13, the second terminals 15 and the conductive parts 17 are made of a stack of copper foil, a copper plating layer, a nickel plating layer and a gold plating layer formed in this order. The copper foil and the plating layers are preferably not less than 10 μm and not more than 50 μm in thickness, respectively.

The image pickup element 21 may be an image sensor (CMOS or CCD). A plurality of electrode terminals 21b are provided on the periphery of the top surface of the image pickup element 21 and electrically connected to the first terminals 13 via thin conductive wires 23, respectively.

The image pickup element 21 includes an image pickup region 21a. As shown in FIG. 4, light receiving elements 22 are provided in the image pickup region 21a. Further, microlenses 24 are provided on the top surface of the image pickup region 21a with their convex surfaces facing upward. The microlenses 24 function to gather light into the light receiving elements 22. In order to gather the light with efficiency, the microlenses 24 preferably have a refractive index in a visible range higher than that of a translucent adhesive 25 to be described later.

The translucent component 27 may be a glass plate or a transparent resin plate for optical use and it is bonded to the top surface of the image pickup element 21 with a translucent adhesive 25. Since the entire bottom surface of the translucent component 27 is bonded to the top surface of the image pickup element 21, there is no need of providing ribs for keeping the bottom surface of the translucent component 27 separated from the top surface of the image pickup element 21. This makes it possible to reduce the size and thickness of the image pickup device 1.

The sealant 29 is made of resin which is poor in optical transmittance. The sealant 29 is provided above the top surface of the substrate 11 such that it is located closer to the substrate 11 than a top surface 27a of the translucent component 27. In a region of the sealant 29 around the translucent component 27, a distance between the top surface of the sealant 29 and the substrate 11 becomes smaller in part of the sealant 29 at a larger distance from the translucent component 27. In other words, in the region of the sealant 29 around the translucent component 27, the thickness of the sealant 29 is slightly smaller in part of the sealant 29 at a larger distance from the translucent component 27.

A recess 29a is formed in the top surface of the sealant 29 to surround the translucent component 27. The top surface of the sealant 29 shows arithmetic average roughness smaller than that of the side surface of the sealant 29. The recess 29a and the difference in arithmetic average roughness will be described later in the explanation of a method for manufacturing the image pickup device 1.

Now, the optical sensitivity of the image pickup device will be explained.

The inventors of the present application have tried to improve the optical sensitivity of the image pickup device by optimizing the relative positions of the translucent component and the sealant. Before the explanation of matters considered by the inventors, a cause of reduction in optical sensitivity of the image pickup device will be described first.

As described above, the image pickup device 1 converts light incident on the image pickup element 21 into an electrical signal and performs analysis such as image analysis based on the electrical signal. Therefore, it is preferred that only the light required for the analysis enters the image pickup device 1 while the entrance of other light (stray light) is prevented. If the stray light enters the image pickup element 21, the analysis cannot be performed properly, resulting in deterioration in performance of the image pickup device 1.

In general, the image pickup device is designed to perform analysis using light incident on the top surface of the translucent component and incorporated into optical equipment or the like such that the light required for the analysis properly enters through the top surface of the translucent component. Therefore, the light required for the analysis hardly enters through the side surfaces of the translucent component. However, in some cases, the stray light may enter the image pickup device through the side surfaces of the translucent component because the translucent component is a glass plate as described above. Therefore, if the stray light passing through the side surfaces of the translucent component is blocked, the unwanted entrance of the stray light into the image pickup device is prevented while the light required for the analysis is not blocked.

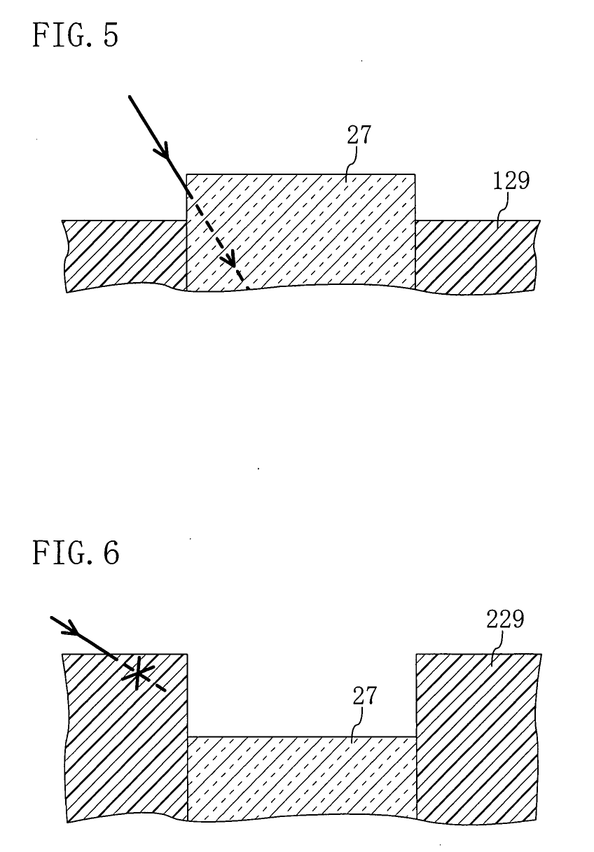

In order to prevent the stray light from entering the image pickup device through the side surfaces of the translucent component, the inventors have studied on image pickup devices shown in FIGS. 5 and 6. FIG. 5 is a sectional view illustrating a major part of a first comparative image pickup device to the present embodiment and FIG. 6 is a sectional view illustrating a major part of a second comparative image pickup device to the present embodiment.

For example, as shown in FIG. 5, when a sealant 129 is provided to be located lower than the top surface of the translucent component 27, the side surfaces of the translucent component 27 are not fully covered with the sealant 129. Therefore, as depicted by an arrow in FIG. 5, stray light enters through part of the side surfaces of the translucent component 27 not covered with the sealant 129. Thus, with the structure shown in FIG. 5, it is impossible to completely prevent the entrance of the stray light.

On the other hand, if a sealant 229 is provided to be located higher than the top surface of the translucent component 27 as shown in FIG. 6, the entrance of the stray light through the side surfaces of the translucent component 27 is completely prevented because the sealant 229 covers all the side surfaces of the translucent component 27. However, light incident on the top surface 27a of the translucent component 27 in an oblique direction is also blocked by the sealant 229 as depicted by an arrow shown in FIG. 6. Therefore, with the structure shown in FIG. 6, the intensity of the light required for the analysis may be reduced. Further, as the angle of the incident light is limited as compared with a device in which the translucent component is not located lower than the sealant, the performance of the optical device is restricted.

In the image pickup device 1 of the present embodiment, as shown in FIG. 3, the sealant 29 is located closer to the substrate 11 than the top surface 27a of the translucent component 27. Therefore, the light required for the analysis is not blocked by the sealant 29 and enters freely the image pickup element 21. Further, since the sealant 29 covers all the side surfaces of the translucent component 27, the stray light is prevented from entering the image pickup device 1 through the side surfaces of the translucent component 27.

In other words, when the image pickup device 1 of the present embodiment is observed from above, the top surface 27a of the translucent component 27 is exposed almost in the middle of the device and surrounded by the sealant 29 provided in close contact with the translucent component 27. When the image pickup device 1 is observed from the side, the sealant 29 is provided in close contact with the substrate 11. As a result, the light required for the analysis surely enters the image pickup element 21 without decreasing its intensity, while light which may possibly cause erroneous analysis results and light unnecessary for the analysis are prevented from entering the image pickup element 21 to the greatest possible extent. Thus, the image pickup device 1 is improved in optical sensitivity.

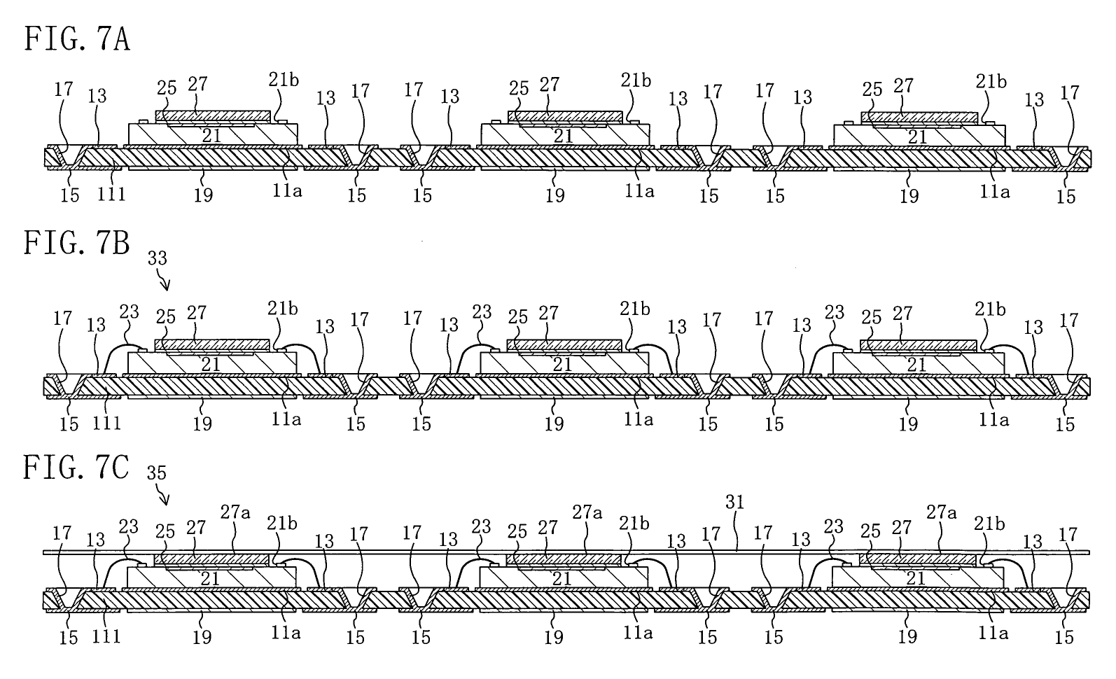

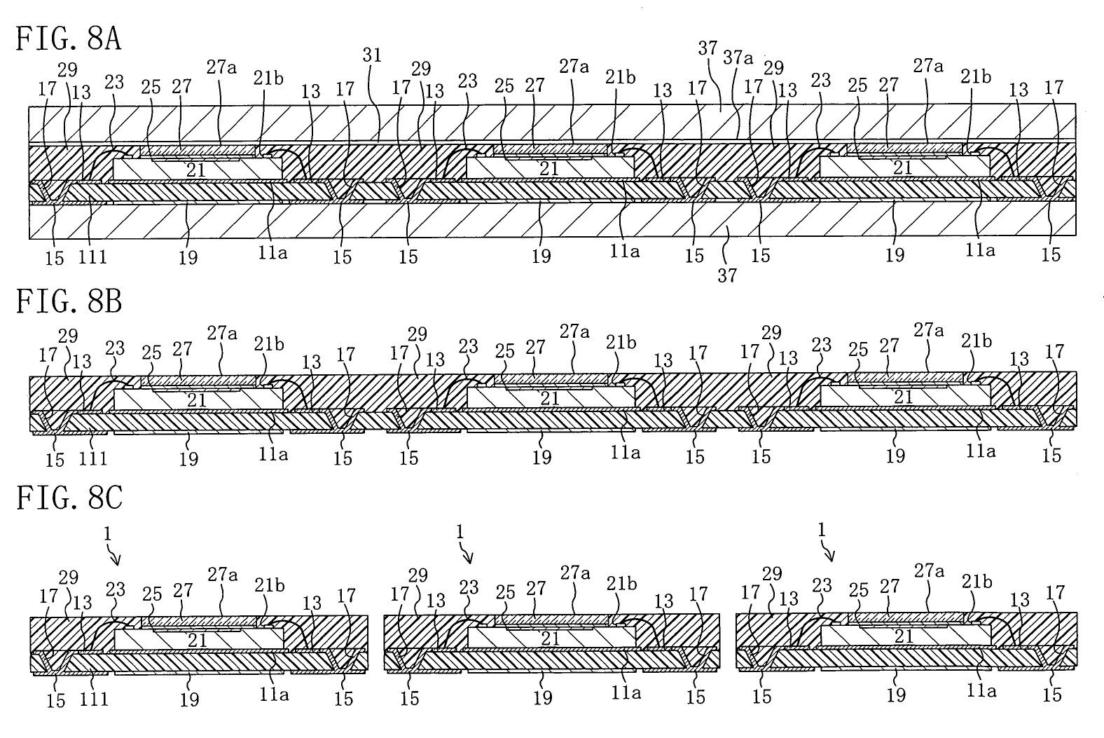

FIGS. 7A to 7C and 8A to 8C are sectional views illustrating the method for manufacturing the image pickup device 1 of the present embodiment. In this method, a mother board 111 provided with a plurality of regions defined on the top and bottom surfaces thereof is prepared, the image pickup elements 21 and the translucent components 27 are mounted on the corresponding regions and the image pickup elements 21 are sealed in the sealant 29. Then, the mother board 111 is divided by the regions to obtain a plurality of image pickup devices simultaneously from the single mother board.

First, as shown in FIG. 7A, a mother board 111 is prepared (step (a)). Specifically, a resin plate on which a plurality of regions are defined in matrix is prepared and a plurality of through holes are formed in each region to penetrate the resin plate in the thickness direction and copper foil is laid on the inner walls of the through holes. Simultaneously, copper foil is provided over the top and bottom surfaces of the resin plate. Then, the top and bottom surfaces of the resin plate are subjected to etching such that the copper foil on the top surface remains in the middle portion and around the through holes, while the copper foil on the bottom surface remains around the through holes. The copper foil remaining around the through holes is connected to the copper foil laid on the inner walls of the through holes. After the etching, a copper plating layer, a nickel plating layer and a gold plating layer are formed in this order on the copper foil. Thus, in each region defined on the mother board, a mount region 11a is defined in the middle of the top surface, while a plurality of first terminals 13 and a plurality of second terminals 15 are provided on the top and bottom surfaces, respectively. The through holes are assumed as conductive parts 17 penetrating the substrate 11.

Subsequently, in each region of the mother board 111, an image pickup element 21 is bonded to the mount region 11a with a conductive adhesive (not shown) (step (b)) and then the bottom surface of a translucent component 27 is bonded to the top surface of the image pickup element 21 with a translucent adhesive 25 (step (c)). For prevention of complex illustration, the image pickup region 21a is not depicted in FIGS. 7A to 7C and 8A to 8C.

Then, as shown in FIG. 7B, in each region of the mother board 111, thin conductive wires 23 are used to connect the electrode terminals 21b of the image pickup element 21 and the first terminals 13, respectively. In this manner, a first intermediate structure 33 is obtained (step (d)).

Then, as shown in FIG. 7C, a sealing film 31 made of PET (polyethylene terephthalate) is laid on all the translucent components 27 of the first intermediate structure 33 to be substantially parallel to the mother board 111 of the first intermediate structure 33. Thus, a second intermediate structure 35 is obtained (step (e)).

Then, as shown in FIG. 8A, the second intermediate structure 35 is placed on a lower die of a pair of molding dies 37. Then, an upper die of the molding dies 37 is shifted downward to bring an inner surface 37a of the upper die of the molding dies 37 into contact with the sealing film 31 of the second intermediate structure 35. Then, fused resin which is poor in optical transmittance is injected in a cavity between the dies (step (f)), thereby sealing the image pickup elements 21, the thin conductive wires 23 and the first terminals 13 in the resin. As the sealing film 31 is laid over the top surfaces 27a of the translucent components 27, the fused resin is prevented from flowing onto the top surfaces 27a of the translucent components 27. This makes it possible to pass the light required for the analysis through the top surface 27a of the translucent component 27 to which the resin is not bonded. Therefore, the light required for the analysis enters the image pickup device 1 without significantly decreasing its intensity. Further, since the resin is introduced between the sealing film 31 and the surface of the mother board 111, all the side surfaces of the translucent component 27 are covered with the resin, thereby preventing the stray light from entering the image pickup device 1 through the side surfaces of the translucent component 27.

The sealing film 31 is removed after the resin is solidified (step (g)). When the sealing film 31 is removed, a recess 29a is formed in the top surface of part of the sealant 29 to surround the translucent component 27.

Then, as shown in FIG. 8C, the mother board 111 is divided by the regions using a dicing saw to obtain a plurality of optical devices 1 (separating step). Since the image pickup devices 1 are obtained by cutting the mother board 111, the side surfaces of the sealant 29 become rough. However, the top surface of the sealant 29 is smoother than the side surfaces thereof because the geometry of the top surface of the sealant 29 is obtained by removing the sealing film 31.

In the method of the present embodiment, the lower die of the molding dies 37 may be shifted upward after the sealing film 31 of the second intermediate structure 35 is brought into contact with the inner surface of the upper die of the molding dies 37.

### Second Embodiment

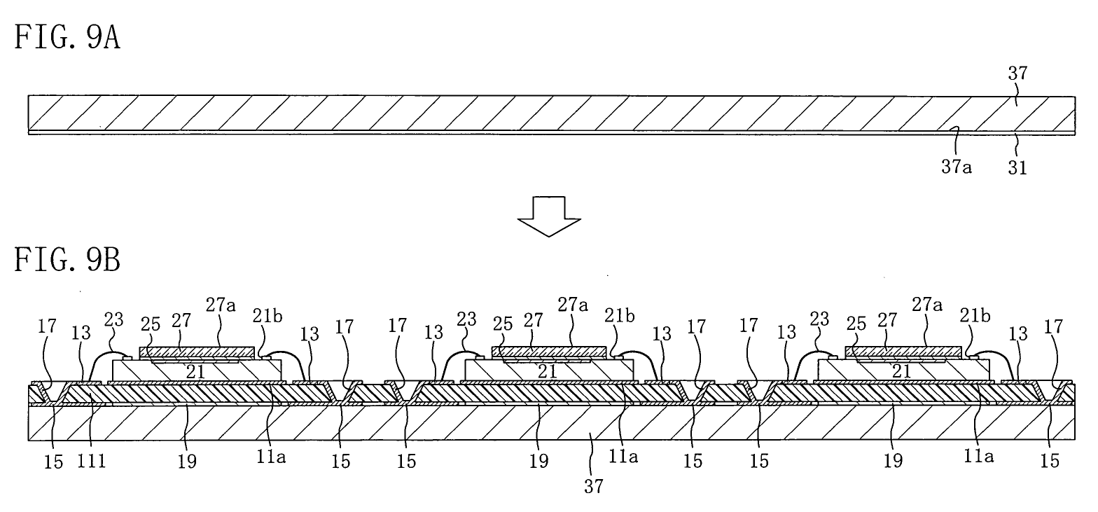

FIG. 9 is a sectional view illustrating some steps of a method for manufacturing an optical device of a second embodiment.

In the present embodiment, the image pickup device shown in FIG. 1 is manufactured by a method different from that described in the first embodiment. According to the method of the present embodiment, the sealing film is laid on the inner surface of the molding die instead of laying it on the top surfaces of the translucent components.

Specifically, the first intermediate structure 33 shown in FIG. 7B is obtained first in the same manner as described in the first embodiment.

Then, as shown in FIG. 9, the sealing film 31 is attached to the inner surface 37a of the upper die of the molding dies 37. Then, the first intermediate structure 33 is placed on the lower die of the molding dies 37. Subsequently, the upper die is shifted downward in the direction shown by an arrow in FIG. 9 such that the sealing film 31 attached to the inner surface 37a of the upper die comes into contact with the top surfaces 27a of the translucent components 27 on the mother board 111 to be substantially parallel to the mother board 111. Thereafter, resin is injected into the cavity between the dies.

After the resin is solidified, the mother board 111 is taken out of the molding dies 37 and divided by the regions.

### Third Embodiment

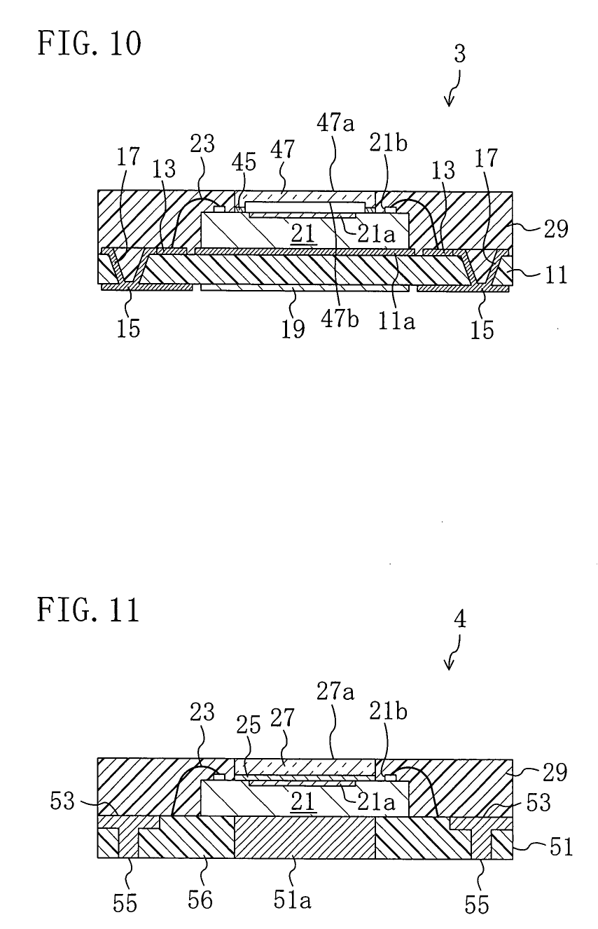

FIG. 10 is a sectional view illustrating the structure of an image pickup device 3 of the third embodiment.

The image pickup device 3 of the present embodiment is different from the image pickup device described in the first and second embodiments in that the periphery portion of the bottom surface of a translucent component 47 is bonded to the image pickup element 21 with an adhesive 45, while the middle portion of the bottom surface of the translucent component 47 is not bonded to the image pickup element 21.

Specifically, the translucent component 47 of the present embodiment has a recess 47b in the middle of the bottom surface thereof. The recess 47b is positioned to correspond with the image pickup region 21a of the image pickup element 21. As described in the first embodiment, the microlenses 24 are provided on the top surface of the image pickup region 21a (not shown in FIG. 10, see FIG. 4). Therefore, the recess 47b is configured to be separated from the surfaces of the microlenses 24. The recess 47b is filled with not an adhesive but air.

Since the translucent component 47 has the recess 47b and the recess 47b is not filled with the adhesive, the translucent component 47 is bonded to the image pickup element 21 without applying the adhesive to the image pickup region 21a of the image pickup element 21. Accordingly, the light passed through the translucent component 47 enters the image pickup region 21a without passing through the adhesive. Therefore, other adhesives than the translucent adhesive may be used as the adhesive 45.

The image pickup device of the present embodiment may be manufactured by the method according to the first or second embodiment described above.

### Fourth Embodiment

FIG. 11 is a sectional view illustrating the structure of an image pickup device 4 of a fourth embodiment.

The image pickup device 4 of the present embodiment has a substrate different from those described in the first to third embodiment.

Specifically, a substrate 51 of the present embodiment is a lead frame filled with resin 56. The lead frame includes a die pad 51a, a hanging lead (not shown) for supporting the die pad 51a, a plurality of first terminals 53 and a plurality of second terminals 55. As the lead frame is filled with the resin 56, electrical insulation between the die pad 51a and the first terminals 53 is maintained.

For example, the lead frame is made of a Ni layer, a Pd layer and an Au layer stacked in this order on a Cu frame. An image pickup element 21 is bonded onto the die pad 51a. The top surface of the lead frame functions as the first terminals 53 and the bottom surface of the lead frame opposite to the first terminals 53 functions as the second terminals 55.

The image pickup device 4 of the present embodiment may include the translucent component described in the third embodiment instead of the translucent component described in the first embodiment.

The image pickup device 4 of the present embodiment may be manufactured by the method described in the first or second embodiment after the substrate 51 is prepared. The substrate 51 may be obtained by attaching sealing films (not shown) on the bottom and top surfaces of the lead frame, respectively, and injecting the resin 56 in the cavities formed between the lead frame and the sealing films.

### Other Embodiments

The above-described embodiments may be modified in the following manner.

In the above-described embodiments, the image pickup element is taken as an example of the optical element. However, the present invention is not limited to the light receiving elements and light emitting elements (e.g., lasers and light emitting diodes) may also be applicable.

The optical device of the present invention is not limited to the image pickup device and a light emitting device may also be used.

The substrate of the present invention is not limited to the resin substrate and the lead frame used in the above-described embodiments.

In the above-described embodiments, a plurality of optical devices are manufactured simultaneously using a mother board. However, the optical devices may be manufactured one by one.

What is claimed is:

1. An optical device comprising:
a substrate;
an optical element mounted on one of the surfaces of the substrate to receive or emit light;
a plate-shaped translucent component whose bottom surface is bonded to a top surface of the optical element;
a plurality of terminals provided on the periphery of said one of the surfaces of the substrate and electrically connected to the optical element; and
a sealant provided on said one of the surfaces of the substrate to seal the optical element therein, wherein
the sealant is located lower than a top surface of the translucent component and
a top surface of the translucent component is exposed out of the sealant a side surface of the translucent component is covered with the sealant.

2. The optical device of claim 1, wherein
a recess is formed in a top surface of part of the sealant to surround the translucent component.

3. The optical device of claim 1, wherein
a recess is formed in a top surface of part of the sealant to surround the translucent component,
the sealant covers all the side surface of the translucent component and
a distance between the top surface of the sealant and the substrate becomes smaller in part of the sealant at a larger distance from the recess surrounding the translucent component.

4. The optical device of claim 1, wherein
the top surface of the sealant has arithmetic average roughness smaller than that of the side surface of the sealant.

5. The optical device of claim 1, wherein
the translucent component is bonded to the optical element with a translucent adhesive.

6. The optical device of claim 1, wherein
the entire bottom surface of the translucent component is bonded to the top surface of the optical element.

7. The optical device of claim 5, wherein
the optical element is an image pickup element for converting received light into an electrical signal,
lenses are provided on the top surface of the image pickup element to gather light into the image pickup element and
the lenses have a refractive index higher than that of the translucent adhesive.

8. The optical device of claim 1 further comprising:
a plurality of conductive parts penetrating the substrate in the thickness direction; and
a plurality of second terminals electrically connected to the plurality of terminals, respectively, wherein
the plurality of terminals are configured to extend from the conductive parts to said one of the surfaces of the substrate and electrically connected to the optical element via a plurality of thin conductive wires and
the plurality of second terminals are configured to extend from the conductive parts to the other surface of the substrate.

9. A method for manufacturing an optical device including an optical element for receiving or emitting light, the method comprising the steps of:
(a) providing a plurality of terminals on the periphery of one of the surfaces of a substrate;
(b) fixing the optical element onto said one of the surfaces of the substrate;
(c) bonding a bottom surface of a plate-shaped translucent component to a top surface of the optical element;
(d) electrically connecting the plurality of terminals and the optical element to provide a first intermediate structure;
(e) laying a sealing film extending substantially parallel to the substrate on a top surface of the translucent component;
(f) injecting resin between the sealing film laid on the translucent component and the substrate to seal the optical element therein; and
(g) removing the sealing film from the translucent component after the step (f).

10. The method of claim 9, wherein the step (e) includes the steps of:
laying the sealing film on the translucent component of the first intermediate structure to provide a second intermediate structure; and
placing the second intermediate structure in a cavity in a pair of molding dies and bringing the sealing film of the second intermediate structure into contact with an inner surface of the cavity.

11. The method of claim 9, wherein the step (e) includes the steps of:
attaching the sealing film onto an inner surface of a cavity in a pair of molding dies; and
placing the first intermediate structure in the cavity and bringing the sealing film attached to the inner surface of the cavity into contact with the translucent component of the first intermediate structure, while the sealing film is kept substantially parallel to the substrate of the first intermediate structure.

12. The method of claim 9, wherein
a mother board provided with a plurality of regions defined on one of the surfaces thereof is used as the substrate and the plurality of terminals are provided in each region in the step (a),
the optical element is fixed to said one of the surfaces of the mother board in each region in the step (b),
a bottom surface of the translucent component is bonded to a top surface of the optical element in each region in the step (c); and
the step (g) is followed by the step of dividing the mother board by the regions to obtain a plurality of optical devices from the single mother board.
